(19) United States
(12) Patent Application Publication
(10) Pub. No.: US 2021/0235721 A1
(43) Pub. Date: Aug. 5, 2021

(54) IMPROVING THE SENSORY QUALITY PROFILE OF PLANT PROTEIN BASED COMPOSITIONS

(71) Applicant: SOCIETE DES PRODUITS NESTLE S.A., Vevey (CH)

(72) Inventors: Josef Kerler, Bern (CH); Sandra Catharina Wilde, Wichtrach (CH)

(21) Appl. No.: 17/251,318

(22) PCT Filed: May 23, 2019
(86) PCT No.: PCT/EP2019/063275

§ 371 Date: Dec. 11, 2020

(30) Foreign Application Priority Data
Jun. 12, 2018 (EP) 18177286.4

(51) Int. Cl. A23J 3/14; A23L 5/20; B01D 71/26; B01D 69/02; B01D 61/24; B01D 63/02

(52) U.S. Cl. CPC A23J 3/14; A23L 5/23; B01D 71/26; B01D 2325/20; B01D 61/246; B01D 63/02; A23V 2002/00; B01D 69/02

(57) ABSTRACT

The invention relates generally to the field of improving the sensor), quality profile of plant protein based compositions. In particular, the invention relates to the removal of undesired plant-like aroma and astringent/bitter taste from plant protein based compositions. For example, the invention relates to a process for improving the sensor), quality of a plant protein containing composition comprising the steps of bringing the plant protein containing composition in contact with a food grade oily composition, and removing the oily phase from the plant protein containing composition.

### TECHNICAL FIELD

The present invention relates generally to the field of improving the sensory quality profile of plant protein based compositions. In particular, the invention relates to the removal of undesired plant-like aroma and astringent/bitter taste from plant protein based compositions.

### BACKGROUND OF THE INVENTION

Plant proteins can be used to create healthful beverages valued by consumers. The plant-based beverage segment experiences a growing demand, which could be further enhanced if undesirable plant based flavour notes (e.g. green-fatty aroma, astringent and bitter taste) could be attenuated and the product flavour profile modulated towards smooth, sweet and nutty characters. To this end, there is high interest in innovative technologies for off-flavor attenuation in plant proteins, which would allow to enlarge the scope of available sources of plant proteins with a high nutritional value for use in ready-to-drink beverages. The present invention relates to a novel process for the attenuation of off-flavours in plant proteins, such as in pea protein, for example, which is often used in beverage formulations as it can be considered a high quality protein source.

WO 2011/124862 A1 to Roquette Freres relates to a process for manufacturing of soluble and functional plant proteins. It is claimed that this process comprising a heat treatment step using steam, followed by cooling and lowering of pressure to 300 mbar, results in a pea protein isolate with a more neutral aroma. This claim is supported by analytical data showing lower contents of hexanal and three pyrazines in the pea protein isolate of the invention.

WO2008/089734 A1 to Fraunhofer-Gesellschaft zur Angewandten Forschung relates to a method to modify the flavor of leguminous plant proteins. Their method involves a thermal reaction of e.g. lupine protein solution in presence of reducing sugars at low pH using temperatures of e.g. 40-70° C. or higher for 30 min. Authors claim that flavor can be modulated towards neutral, cooked milk, nutty or caramel notes. However, the addition of sugars together with a change in pH cannot be considered as a gentle process.

WO 2006/102907 A1 to Hamlet Protein relates to yeast fermentation to attenuate anti-nutritional factors and improve the organoleptic quality of pulse proteins like soya and lupine. It is claimed that the fermentation step leads to a significant reduction in alcohols with undesirable odor (e.g. exhibiting green notes), whereas other volatiles (alcohols e.g. malty notes, ester) with desirable odor qualities are formed.

EP 0943 245 A1 to Protein Technologies International relates to a extraction process to produce an isoflavone depleted vegetable protein, which can be combined with the purified isoflavone extract to tailor nutritional benefits of the protein fraction. The extraction process involves the use of solvents like methanol, ethanol, propanol, ethyl acetate and acetonitrile.

US 2006/0073250 A1 to SOLAE LLC discloses the use of an adsorption resin to remove undesirable low molecular weight compounds from soy protein material.

U.S. Pat. No. 4,259,364 relates to a method for improving the flavour quality of texture soy protein by an oxidation treatment with an aqueous solution of a bromate or iodate salt.

None of the prior art processes, which are mentioned above, involve an oil extraction step. The inventors have found that such an oil extraction is a gentle process that—while improving the sensory quality of the plant protein composition—avoids to induce changes of the plant protein composition itself. A gentle process, which is capable of attenuating undesirable plant-like notes as well as bitter and astringent taste without altering the protein composition nor having any impact on labelling of the plan protein material is so far not existing.

### SUMMARY OF THE INVENTION

The object of the present invention is to improve the state of the art, and in particular to provide a process that overcomes the problems of the prior art and addresses the needs described above, or at least to provide a useful alternative.

The inventors were surprised to see that the object of the present invention could be achieved by the subject matter of the independent claim. The dependent claims further develop the idea of the present invention.

Accordingly, an embodiment of the invention proposes a process for improving the sensory quality of a plant protein containing composition comprising the steps of bringing the plant protein containing composition in contact with a food grade oily composition, and removing the oily phase from the plant protein containing composition.

The subject matter of the present invention allows it to provide a process that overcomes the problem of off-note attenuation of plant proteins without applying any thermal or fermentative step.

The inventors were surprised to see that the extraction of plant protein solutions by means of edible oils resulted in a very significant attenuation of undesirable plant-like and green fatty characters as well as led to a reduction in bitterness and astringency. The invention offers a new solution for improving the organoleptic qualities of plant proteins without any negative impact on the protein composition and quality.

These and other aspects, features and advantages of the invention will become more apparent to those skilled in the art from the detailed description of embodiments of the invention, in connection with the attached drawings.

### BRIEF DESCRIPTION OF THE DRAWINGS

FIG. 1 shows the content (%) of dissolved pea protein isolate (type Nutralys XF from Roquette Frères SA) before and after pre-treatment (as described in example 1) relative to the total protein content.

FIG. 2 shows the particle size distribution of Nutralys XF pea protein dispersion before and after pre-treatment (as described in Example 1).

FIG. 3 shows the process flow for Nutralys XF pea protein isolate pre-treatment and extraction with medium chain triglyceride (MCT).

FIG. 4 shows the overlayed GC/MS chromatograms of MCT oil extracted vs. non-extracted pea protein isolate solutions, highlighting the decrease in aroma compounds that are associated with green, fatty and plant-like notes.

FIG. 5 shows the content (%) of off-note markers in pea protein isolate (12% TS) after membrane extraction relative to the reference PPI before extraction (Example 4).

Table 1 shows the sensory results of the MCT oil extracted pea protein isolate solution as compared to the non-extracted reference.

Table 2 shows the contents (%) of targeted aroma compounds in MCT oil extracted pea protein isolate relative to the non-extracted pea protein isolate (reference)

### DETAILED DESCRIPTION OF THE INVENTION

As used in the specification, the words “comprise”, “comprising” and the like are to be construed in an inclusive sense, that is to say, in the sense of “including, but not limited to”, as opposed to an exclusive or exhaustive sense.

As used in the specification, the word “about” should be understood to apply to each bound in a range of numerals. Moreover, all numerical ranges should be understood to include each whole integer within the range.

As used in the specification, the singular forms “a”, “an”, and “the” include plural referents unless the context clearly dictates otherwise.

As used in the specification, the term “substantially free” means that no more than about 10 weight percent, preferably no more than about 5 weight percent, and more preferably no more than about 1 weight percent of the excluded material is present. In a preferred embodiment, “substantially free” means that no more than about 0.1 weight percent of the excluded material remains. “Entirely free” typically means that at most only trace amount of the excluded material is present, and preferably, no detectable amount is present. Conversely, “substantially all” typically means that at least about 90 weight percent, preferably at least about 95 weight percent, and more preferably at least about 99 weight percent of the material is present.

Unless noted otherwise, all percentages in the specification refer to weight percent, where applicable.

Unless defined otherwise, all technical and scientific terms have and should be given the same meaning as commonly understood by one of ordinary skill in the art to which this invention belongs.

The term “aroma” is defined as an odour, sensed through the nose orthonasally and retronasally, and also through the back of the mouth where the nasal and mouth cavities are interlinked.

The term “taste” is defined as the sense experienced by the tongue and describes sensations of saltiness, sweetness, sourness, bitterness or umami.

The term “flavour” is defined as a combination of both aroma and taste.

The term “sensory quality” is defined as a combination of texture, flavor and visual aspects.

Accordingly, the present invention provides a process for improving the sensory quality, i.e. flavour quality, of a plant protein containing composition comprising the steps of
(a) Bringing the plant protein containing composition in contact with a food grade oily composition,
(b) Removing the oily phase from the plant protein containing composition.

A plant protein containing composition is a composition which contains plant proteins. Plant proteins are highly valued as alternative protein sources, for example, for dairy based hybrid and non-dairy products based on their protein compositions exhibiting good nutritional value.

As plant protein, any food grade plant protein may be used. The plant protein containing composition may contain at least 20 weight-%, at least 30 weight-%, at least 40 weight-%, at least 50 weight-%, at least 60 weight-%, at least 70 weight-%, at least 80 weight-%, or at least 90 weight-% plant protein. The plant protein containing composition may also consist of plant protein.

For example, the plant protein containing composition may be a plant protein isolate. Plant protein isolates are protein enriched fractions obtained from plants, parts of plants, combinations of plants, combinations of parts of plants, or combinations thereof.

For example, the plant protein containing composition may comprise or consist of plant proteins selected from the group consisting of legume based protein, cereal based protein, algae based protein, seed and/or nut-based protein, or combinations thereof, for example, plant proteins selected from the group consisting of quinoa protein, buckwheat protein, millet protein, oat protein, rice protein, hemp protein, peanut protein, almond protein, cashew protein, coconut protein, lentil protein, water lentil protein, soy protein, faba bean protein, pea protein, chickpea protein, lupin protein, canola protein, sunflower protein, pumpkin seed protein, chia seed protein, watermelon seed protein, flax seed protein, potato protein, microalgae protein, or combinations thereof.

A typical drawback of using plant protein containing compositions that are currently available in the state of the art in hybrid dairy products is often their negative impact on the sensory quality of the product, i.e. lower smooth and creamy notes like in dairy ingredients or products, and other perceivable off-notes as well as their high astringency and bitterness.

The process described in the present invention offers a potential solution to attenuate such off-aromas and off-tastes, for example from aqueous protein solutions.

In accordance with the present invention, the plant protein containing composition may be brought into contact with the food grade oily composition by any means known in the state of the art, which allows the transfer of a part of the molecules from the plant protein containing composition into the oily phase. Such molecules include, for instance, hexanal, heptan-2-one, heptanal, nonanal, 2,4-decadienal, 3,5-octadien-2-one, 1-octen-3-ol, 1-hexanol, 2-pentylfurane and/or saponins.

Any suitable method for contact of the plant protein containing composition with an oil may be used; such methods are well known in the art.

Any suitable oil may be used. Such suitable oils are food grade oils. The oil is preferably selected from the group consisting of vegetable oil, such as soybean oil, canola oil, corn oil, sunflower oil, palm oil, safflower oil, coconut oil, coffee oil, medium chain triglyceride (MCT) oil, or a fraction or a combination thereof.

Traditional solvent extraction technologies may be used if the contact is performed as a contact between liquid oil and a liquid plant protein containing composition.

For example, in step a. the plant protein containing composition may be mixed with the food grade oily composition. In step b. the oily phase is then removed from the plant protein containing composition.

If the plant protein containing composition is not liquid, it may be advisable to add a polar solvent to the plant protein containing composition in order to ensure that there is an optimal exchange between the plant protein containing composition and the food grade oily composition. Hence, in one embodiment, the plant protein containing composition is brought into contact with a food grade polar solvent before the plant protein containing composition is combined with the food grade oily composition.

As food-grade polar solvent, any food-grade polar solvent may be used. For example, the food grade polar solvent may be selected from the group consisting of ethanol, water or combinations thereof.

The total solid content of the plant protein in food-grade polar solvent, for example water, should be between 1 and 30%, 3 and 20%, 5 and 10%, or 3 and 15%, or 5 and 15%.

The plant protein containing composition may also be brought in contact with the food grade oily composition by means of a membrane. Bringing the two compositions into contact by means of a membrane has several advantages. For example, as the membrane is used for the generation of a phase interface between the two liquid phases involved in extraction, additional equipment for the generation of droplets as well as phase separation afterwards is no longer necessary.

Hence, in accordance with the present invention, the plant protein containing composition may be brought into contact with the food grade oily composition via a membrane. Feasible are for example co-current mode or counter-current mode. The inventors have found that of the two the counter current mode is usually more efficient. Hence, in the process of the present invention, the plant protein containing composition may be brought into contact with the food grade oily composition via a membrane in a counter current mode.

Various column devices, mixer-settlers, etc. are known in the art and may be applied to optimise the area of contact between the liquids, and the separation of the liquids. Membrane based technologies may also be applied, as membranes may be used to immobilise the surface between the oil and the plant protein containing composition, and problems such as emulsification and other difficulties in separating the liquid phases may be avoided.

A porous hydrophobic membrane may be used to contact the plant protein containing composition and the oily composition. This may e.g. be performed in a system with hollow fibres of a hydrophobic membrane material wherein the oil is present on the inside of the hollow fibres and the plant protein containing composition on the outside and the contact takes place at the membrane surface.

In another embodiment the plant protein containing composition is present within the hollow fibres and the oily composition is located outside the hollow fibres. The contacting may be done continuously by streaming the plant protein containing composition and the oil, in either a counter-current or co-current manner. A hydrophobic membrane material with a pore size suitable to prevent mixing of the fluid streams may be used. A preferred membrane material is a polypropylene membrane with an average pore size between about 0.01 and 0.05 μm.

The protein containing composition stream is preferably maintained at slightly higher pressure than the oil stream, such that a slight pressure gradient across the membrane is maintained to prevent dispersion of the liquid streams. Due to the hydrophobic nature of the membrane and the surface tension of the aqueous stream with the membrane, the protein containing composition stream does not penetrate the membrane even when slight pressure is applied. Thus, dispersion of the two fluid streams is prevented.

One extraction step in accordance with the present invention is sufficient to achieve a significant improvement of the sensory quality of the plant protein containing composition obtained by the process of the present invention. Those skilled in the art will be able to devise the extraction time appropriately. For example, each extraction step may be carried out for 10 seconds-5 minutes, 20 seconds-2 minutes or 30 seconds-1 minute.

The inventors have found that the sensory quality of the plant protein containing composition obtained by the process of the present invention can be further improved, if the extraction step is repeated. The extraction step may be repeated by repeating mixing and phase separation steps or by repeating the extraction via a membrane steps. Also, combinations of mixing and phase separation steps and extraction via a membrane steps may be used. Hence, in the process of the present invention steps a and b may be repeated several times, for example one, two, three, four five, six, seven eight, nine or ten times.

The inventors have further found that the dissolution properties, i.e. % of dissolved pea protein isolate as well as lower particle size distribution, of the plant protein containing composition can be optimised, if the plant protein containing composition is gently heated during dissolution in combination with a homogenisation step, before it is brought into contact with the food grade oily composition. This may result in an improved sensory quality. For example, the plant protein containing composition may be heated to a temperature in the range of 30-95° C., 40°-60° C., or 45-55° C. Depending on the circumstances, higher temperatures may be desirable. While higher temperatures typically require a higher energy input and may cause some changes, e.g. degeneration, in the protein composition, the inventors have found that very good results can be obtained when the plant protein containing composition is heated to a temperature in the range of 70-170° C., 80°-160° C., or 90-150° C. Alternatively or additionally, the food grade oily composition may be heated to a temperature in the range of 70-170° C., 80°-160° C., or 90-150° C.

Also, the plant protein containing composition may be homogenized before it is brought into contact with the food grade oily composition. The inventors have found that this will further improve the sensory quality of the resulting plant protein containing composition in terms of reduced sandiness perception. For example, the homogenization step may be carried out as follows: two-stage homogenization at 200+50 bar at 70° C.

Hence, in one embodiment of the present invention, the plant protein containing composition is heated to a temperature in the range of 30-95° C., 40°-60° C., or 45-55° C., optionally followed by homogenization, before it is brought in contact with a food grade oily composition. These two pre-treatment processing steps prior to the oil extraction step resulted in an enhancement of the protein isolate dissolution yields as well as a lower particle size of the dispersion, which in consequence can be associated with a lower perceived sandiness of the solution.

If the oil extraction step is carried out via a membrane, the inventors have found that in particular promising results are achieved, if a membrane is used that contains a porous polypropylene material with a cut off size range between 0.01 and 0.1 μm. If several extraction steps are used the material of the membrane may be kept the same.

The inventors have found that a particular effective extraction can be achieved, if the counter current circulation rate of the plant protein containing composition and oily streams is in the range of 10 g to 10 kg per min.

Similarly, a particular effective extraction could be achieved, if the pressure of the two phases is was the range of 0.1 to 1 bar.

Further, good results were achieved when the temperature of the phases was in the range of 5 to 70° C.

The inventors were surprised that the combination of these three features led to a plant protein containing composition with a remarkably improved sensory quality, better than could have been expected based on the result obtained with each of the features individually.

Hence, in one embodiment of the present invention, the plant protein containing composition is brought into contact with the food grade oily composition via a membrane in a counter current mode, wherein the counter current circulation rate of the plant protein containing composition and oily streams is in the range of 10 g to 10 kg per min, the pressure of the two phases is in the range of 0.1 to 1 bar, and/or the temperature of the phases is in the range of 5 to 70° C.

An extraction of the plant protein containing composition will be achieved, whenever an amount of the plant protein containing composition is brought into contact with any amount of oil in the oily phase. However, particular promising results were obtained when the food grade polar solvent naturally present in the plant protein containing composition or added to the plant protein containing composition was used in certain relative amounts compared to the food grade oily composition. Accordingly, the food grade oily composition that is brought into contact with the plant protein containing composition or the mixture of the plant protein containing composition and the food grade polar solvent may be used in a volume ratio in the range of 1:10-5:10, 2:10-4:10, or 2.5:10-3.5:10.

The plant protein containing composition can be used directly as obtained from the extraction process. Alternatively, the volume of the food grade polar solvent in the plant protein containing composition can be reduced. For example, the content of food grade polar solvent in the plant protein can be reduced so that the resulting plant protein containing composition is substantially free from food grade polar solvents. This will help to reduce the weight of the composition, which would be helpful if the composition is transported before it is used in a final composition. Also, the plant protein containing composition can be dried. This would further reduce the weight and would increase storage stability. Hence, in one embodiment of the present invention the plant protein containing composition is dried, e.g., to powder form. This drying can occur after the extraction is completed, for example after the last removal of the oily phase.

Removal of the oily phase means interrupting the contact between the oily phase and the polar phase. This includes a phase separation or the interruption of the contact via an interface, such as a membrane, for example.

An advantage of the process described in the present invention is that it allows to improve the sensory quality of a plant protein containing composition. Improving the sensory quality may include improving the texture, flavor and/or visual aspects of a plant protein containing composition. Improving the flavor may include improving the aroma and/or taste of the plant protein containing composition.

The inventors have found that the process of the present invention is in particular effective in improving the flavor of the plant protein containing composition. Hence, in one embodiment of the present invention improving the sensory quality may mean improving the flavor of the plant protein containing composition.

The inventors have found that the sensory quality of a plant protein containing composition, in particular the flavor of a plant protein containing composition is achieved by reducing off-aromas and/or off tastes.

In this respect in one aspect of the present invention, improving the sensory quality may mean improving the aroma of the plant protein containing composition. In another aspect of the present invention, improving the sensory quality may mean improving the taste of the plant protein containing composition.

For example, improving the sensory quality and/or the aroma of the plant protein containing composition may be achieved by reducing off-aromas such as green, fatty, plant-like, pea-like, and/or cereal notes. Further, for example, improving the sensory quality and/or the taste of the plant protein containing composition may be achieved by reducing off-tastes, such as astringent and/or bitter tastes. Hence, in accordance with the present invention the sensory quality and/or the flavor of the plant protein containing composition may be achieved by reducing off-aromas such as green, fatty, plant-like, pea-like, and/or cereal notes and/or off-tastes, such as astringent and/or bitter tastes.

Without wishing to be bound by theory, the inventors currently believe that the improvement of the sensory quality of the plant protein containing composition is achieved by the at least partial removal of certain odorants in the plant protein containing composition through extraction. Accordingly, in the framework of the present invention, improving the sensory quality of a plant protein containing composition can be associated to the reduction in contents of aroma compounds such as hexanal, heptan-2-one, heptanal, nonanal, 2,4-decadienal, 3,5-octadien-2-one, 1-octen-3-ol, 1-hexanol and 2-pentylfurane in the plant protein containing composition.

Also, in the framework of the present invention, improving the taste of a plant protein containing composition can be associated to the reduction of tastants such as saponins in the plant protein containing composition.

Those skilled in the art will understand that they can freely combine all features of the present invention disclosed herein. Further, features described for different embodiments of the present invention may be combined.

Furthermore, where known equivalents exist to specific features, such equivalents are incorporated as if specifically referred in this specification. Further advantages and features of the present invention are apparent from the figures and non-limiting examples.

Although the invention has been described by way of example, it should be appreciated that variations and modifications may be made without departing from the scope of the invention as defined in the claims.

### EXAMPLES

### Example 1: Process for Solubilisation and Oil Extraction of Pea Protein Isolate

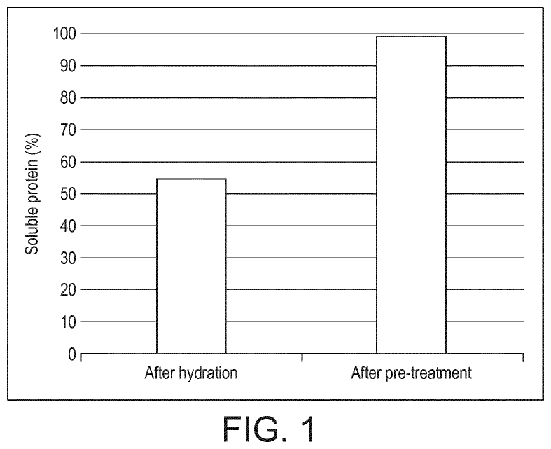

Pea protein isolate (PPI) Nutralys XF was provided by Roquette Frères SA (France). The pea protein was added to reverse osmosis water at 50-55° C. and stirred for 30 minutes to achieve a solution at 5-6% total solids. The protein dispersion has been heated to 95° C. for 10 min using a coiled tube (4 mm internal radius, 7 windings 94 mm diameter, 2100 cm length) immersed in an oil bath at 110° C. (HBR4 IKA, Germany). The flow rate was of 425 mL/min in order to make sure that at the exit of the coil the target temperature of 95° C. was reached. The heated dispersion was collected in a Schott bottle placed in a water bath at 95° C. (HBR4 IKA, Germany) and provided with a magnetic stirrer. The PPI dispersion was stirred at 95° C. for 10 min, before being cooled in a cold water bath to 50° C., followed by homogenisation at 200+50 bar in a bench top homogenizer Panda PLUS (GEA Niro Soavi, Italy). The above described heat treatment plus homogenisation steps resulted in an increased and almost complete dissolution of the pea protein (FIG. 1). Protein solubility was evaluated based on total nitrogen using a standard Kjeldahl methodology. Analyses were carried out in duplicate for each of the following samples: (i) entire aqueous solution of PPI (total protein) and (ii) supernatant after centrifugation at 3000×g/15 min at room temperature (soluble protein). The ratio of soluble protein was calculated as follows:

Soluble protein (%)=Nitrogen concentration in supernatant/Total Nitrogen concentration×100

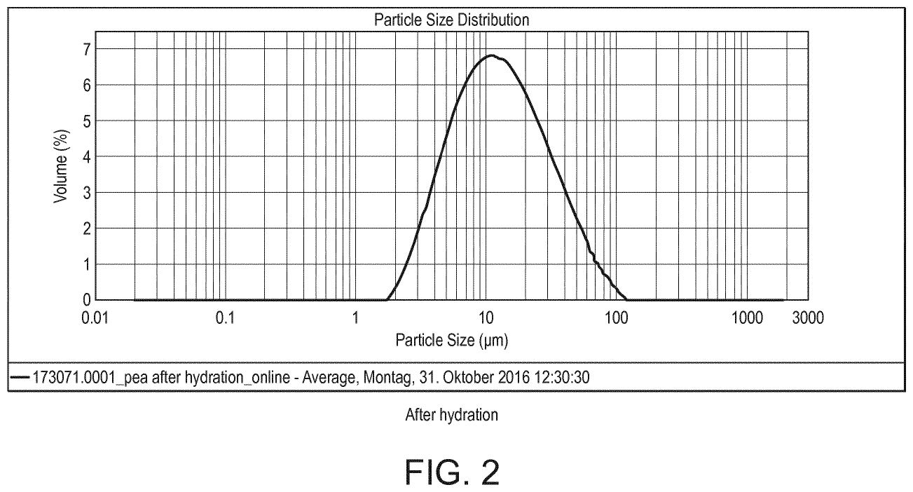

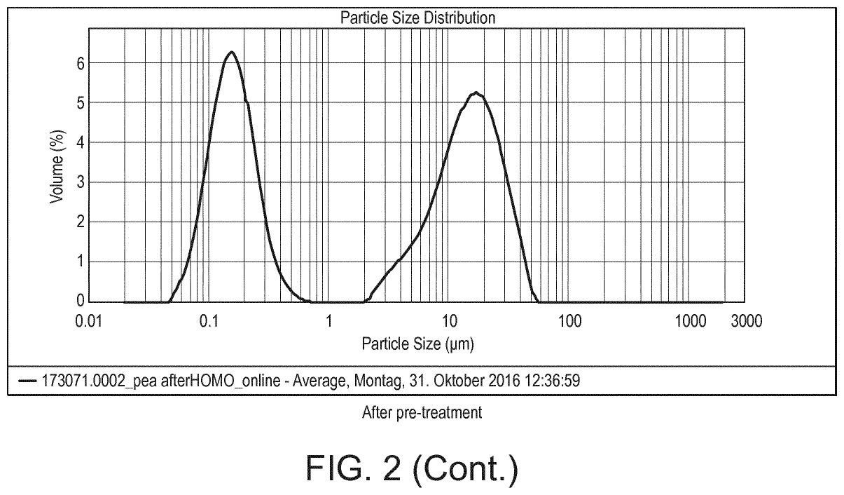

In addition, particle size distribution (PSD) has been analysed using a Malvern MasterSizer equipped with a large volume automated wet dispersion accessory to determine the average diameter of the emulsion droplets. As shown in FIG. 2, PSD has been reduced to below 1 micron for ca. half of the particles.

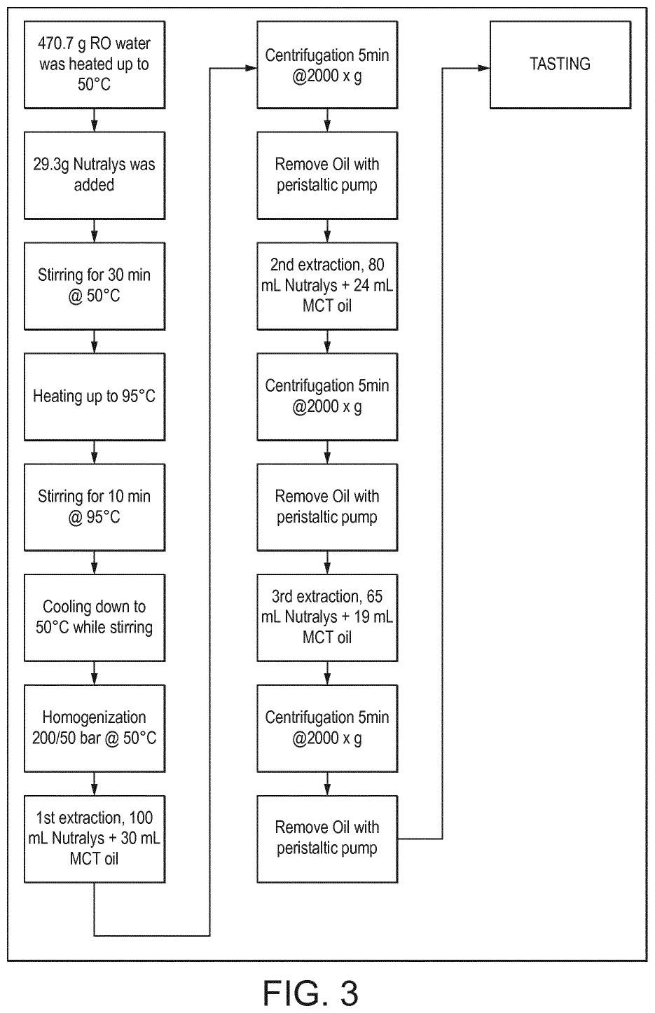

After above described pre-treatment steps, the obtained PPI aqueous solution was extracted with medium chain triglyceride (MCT) oil, using a water to oil ratio of ca. 3:1 (v/v; e.g. 100 ml of PPI extracted with 30 ml of MCT oil). Extraction was carried out by shaking both PPI solution and oil in a separatory funnel for 30 seconds, followed by centrifugation for 5 min at 2000×g. After ca. 20 min, phase separation was completed and aqueous phase (80 ml) was collected. The extraction procedure was repeated in the same manner two more times. An overview of the whole process is outlined in FIG. 3. The recovered PPI aqueous solution was used for tastings to evaluate the degree of flavour attenuation (see Example 2) in comparison the PPI solution before MCT oil extraction (reference). In addition, PPI aqueous solutions were analysed by SPME-GC/MS to evaluate the degree of attenuation in volatile compounds (see Example 3).

### Example 2

The pea protein isolate (PPI) solutions at 5% total solids before (reference) and after medium chain triglyceride (MCT) oil extraction were evaluated sensorially by a 5-membered panel. PPI solutions were distributed in small plastic beakers and assessed orthonasally (sniffings) as well as retronasally in mouth (tasting). Panelists rated the intensity of each aroma and taste descriptors using a 5 point scale from 0 (absent) to 5 (highest intensity). Results are summarised in Table 1.

TABLE 1

| | Sensory intensity^{a} | |
|---|---|---|
| | PPI solution before MCT | PPI solution after MCT oil |
| Sensory attribute | oil extraction (reference) | extraction |
| Aroma | | |
| pea-like | 4 | 0 |
| green-fatty | 3.5 | 0 |
| cereal-floury | 4 | 2 |
| Taste | | |
| Bitter | 4 | 1 |
| astringent | 4 | 2 |

^{a}scale from 0 (note detected) to 5 (highest intensity)

Results demonstrate a complete reduction of pea-like (from 4 to 0) and green-fatty (from 3.5 to 0) notes through the MCT oil extraction. In addition, the MCT extracted PPI solution showed a significant lower intensity of cereal-floury aroma note (from 4 to 2) as well as lower astringent (from 4 to 2) and bitter (from 4 to 1) taste as compared to the reference. The inventors find that the attenuation of astringent and bitter taste is a surprising result as components such as saponins, for example, are usually present in form of glycosides in the plant material.

### Example 3

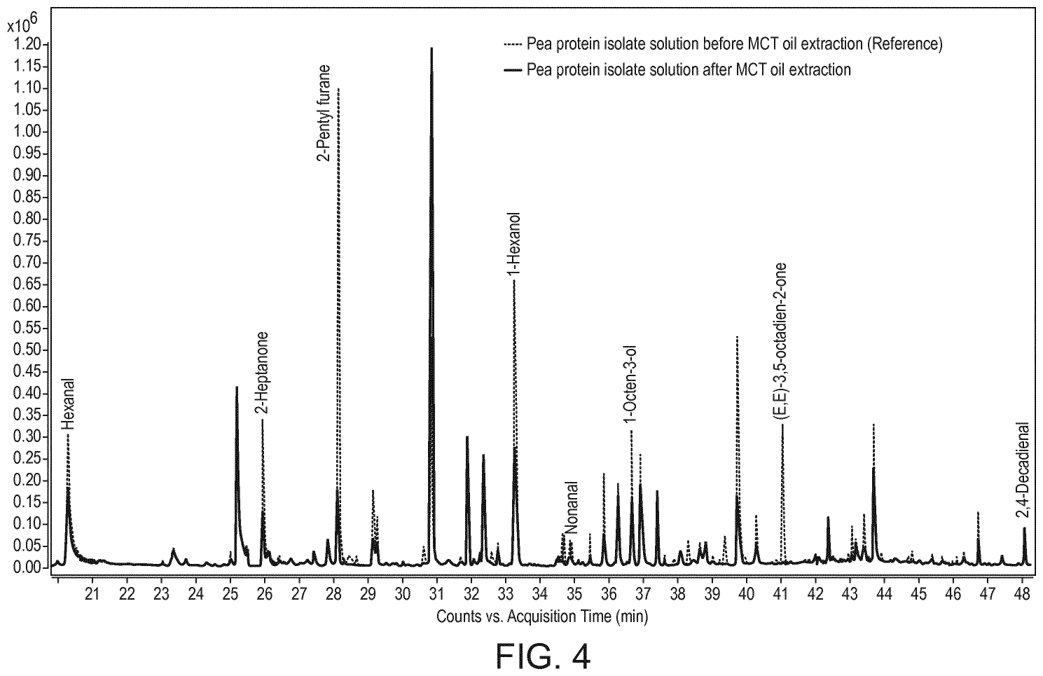

The pea protein isolate (PPI) solutions at 5% total solids before (reference) and after medium chain triglyceride (MCT) oil extraction were evaluated analytically by means of a solid phase micro extraction (SPME)-GC/MS methodology. The extraction process was the same as outlined in Example 1. Aliquots (5.5 g) of both samples were added together with sodium chloride (1.8 g) into 20 ml SPME vials and incubated at 65 C for 30 min. The volatiles from the headspace of each of the samples were then extracted by SPME using a 2 mm DVB/CAR/PDMS solid phase micro extraction fiber (Supelco). After thermal desorption, volatiles were analysed by GC/MS (TIC mode) using a HP-FFAP column (50 m). Results, which are shown in FIG. 4 (overlayed chromatograms) as well as Table 2 (relative contents (%) of targeted key aroma components), show a significant reduction of aroma compounds such as hexanal, hepan-2-one, heptanal, nonanal, 2,4-decadienal, 3,5-octadien-2-one, 1-octen-3-ol, 1-hexanol and 2-pentylfurane in the MCT oil extracted pea protein isolate, correlating well with the reduced intensity of aroma attributes such as pea-like, green-fatty and cereal-floury.

TABLE 2
Pea protein isolate solution after MCT oil extraction

| | relative amounts |
|---|---|
| Selected Compounds | based on reference sample |
| hexanal | 56% |
| 2-heptanone | 33% |
| 2-pentyl furane | 15% |
| 1-hexanol | 46% |
| nonanal | 57% |
| 1-octen-3-ol | 50% |
| (E,E)-3,5-octadien-2-one | 3% |
| 2,4-decadienal | 69% |

### Example 4

A pea protein isolate (PPI) (type Nutralys XF from Roquette Frères SA France) solution at a total solid content of 12% was prepared using the method described in Example 1. The PPI solution was then circulated through a hollow fiber membrane module (shell side of a Liqui-Cel EXF-4x28 module with ×50 fibres; surface: 20 m²; supplier: 3M). In counter-current mode, MCT oil was passed through the lumen side of the membrane module, giving rise to the extraction of off-note components from the PPI solution through the membrane interface. Process conditions can be summarised as follows:

Temperature of PPI solution: 60° C.

Overpressure shellside: 0.4 bar

Flow rates of PPI solution and MCT oil were adjusted to achieve distillate to oil (D/O) ratios of 32 to 128 (v/v)

PPI solutions before and after extraction were evaluated analytically by means of a solid phase micro extraction (SPME)-GC/MS methodology using the same method as outlined in Example 3.

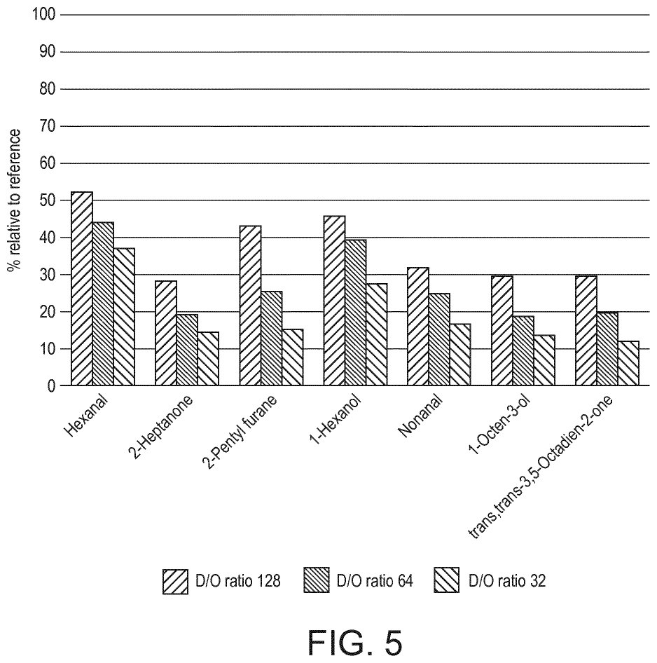

Results shown in FIG. 5 reveal a significant reduction of aroma compounds such as hexanal, hepan-2-one, heptanal, nonanal, 3,5-octadien-2-one, 1-octen-3-ol, 1-hexanol and 2-pentylfurane in the PPI solution after membrane extraction. The lower the D/O ratio, the higher the decrease in aroma marker compounds which contribute to the off-flavour. This result is consistent with both the analytical data of Example 3 as well as the reduced intensity of aroma attributes such as pea-like, green-fatty and cereal-floury of Example 2.

1. Process for improving the sensory quality of a composition which contains plant proteins, the process comprising the steps of
a. bringing the plant protein containing composition in contact with a food grade oily composition; and
b. removing the oily phase from the plant protein containing composition.

2. Process in accordance with claim 1, comprising the step that the plant protein containing composition is brought into contact with a food grade polar solvent before the plant protein containing composition is combined with the food grade oily composition.

3. Process in accordance with claim 1, wherein the plant protein containing composition is brought into contact with the food grade oily composition via a membrane in a counter current mode.

4. Process in accordance with claim 1, wherein steps a and b are repeated several times.

5. Process in accordance with claim 1, where the plant protein containing composition is heated, before it is brought in contact with a food grade oily composition.

6. Process in accordance with claim 3, wherein the membrane contains a porous polypropylene material with a cut off size range between 0.01 and 0.1 micron.

7. Process in accordance with claim 3, wherein the counter current circulation rate of the plant protein containing composition and oily streams is in the range of 10 g to 10 kg per min, the pressure of the two phases is in the range of 0.1 to 1 bar, and/or the temperature of the phases is in the range of 5 to 70° C.

8. Process in accordance with claim 1, wherein the food grade oily composition is selected from the group consisting of vegetable oil, and medium chain triglyceride (MCT) oil, or a fraction or a combination thereof; and wherein the food grade polar solvent is selected from the group consisting of ethanol, water and combinations thereof.

9. Process in accordance with claim 1, wherein the food grade oily composition that is brought into contact with the plant protein containing composition or the mixture of the plant protein containing composition and the food grade polar solvent is used in a volume ratio in the range of 1:10-5:10.

10. Process in accordance with claim 1, wherein the plant protein containing composition is dried after the last removal of the oily phase.

11. Process in accordance with claim 1, wherein the plant protein containing composition comprises plant proteins selected from the group consisting of legume based protein, cereal based protein, algae based protein, seed and/or nut-based protein, and combinations thereof.

12. Process in accordance with claim 1, wherein improving the sensory quality means improving the flavor of the plant protein containing composition.

13. Process in according with claim 1, wherein improving the sensory quality of the plant protein containing composition is achieved by reducing off-aromas, off-taste, and bitter tastes.

14. Process in according with claim 1, wherein improving the sensory quality of a plant protein containing composition is achieved by the reduction of hexanal, heptan-2-one, heptanal, nonanal, 2,4-decadienal, 3,5-octadien-2-one, 1-octen-3-ol, 1-hexanol, 2-pentylfurane and saponins in the plant protein containing composition.
